(19) United States
(12) Patent Application Publication
(10) Pub. No.: US 2006/0251126 A1
(43) Pub. Date: Nov. 9, 2006

(54) Method and device for synchronizing clock at transport stream receiving end

(76) Inventor: Teng-Yi Jen, Hsin-Chu City (TW)

Correspondence Address: BACON & THOMAS, PLLC, 625 SLATERS LANE, FOURTH FLOOR, ALEXANDRIA, VA, 22314, US

(21) Appl. No.: 11/120,970

(22) Filed: May 4, 2005

(51) Int. Cl. H04J 3/14; H04J 1/16; H04L 1/00; H04L 12/26; H04J 3/22; H04J 3/16; H04J 3/06

(52) U.S. Cl. 370/503; 370/229; 370/465

(57) ABSTRACT

A clock synchronizing device at a transport stream receiving end is provided. The device contains a FIFO buffer, a stream shaper, a controllable clock generator, and a clock adjustment module. When the clock at the transmitting end runs faster than the clock at the receiving end, the packet volume of the buffer rises to a high threshold and the device accelerates its clock generator so that the packets in the buffer are consumed faster. When the clock at-the transmitting end runs slower than the clock at the receiving end, the packet volume of the buffer drops to a low threshold and the device slows down its clock generator so that the packets in the buffer are consumed slower. The most significant feature of the device is that the default frequency and adjustment quantity of its clock generator is adapted according to how fast the packets accumulate or deplete in the buffer.

### BACKGROUND OF THE INVENTION

1. Field of the Invention

The present invention generally relates to transport streams, and more particularly to a device and method for synchronizing stream clock at a receiving end of a transport stream system.

2. The Prior Arts

The widespread popularity of Internet prompts a new trend in digital transmission and this new trend is rapidly changing the analog world which people are familiar with. Voice-over-IP (VoIP) has already been proven to produce comparable quality with the hundred-years-old analog phones. Video streaming, the digital version of analog video broadcasting, despite in the early developing phase, is demonstrated by various pilot projects and field trials to have a great potential of full-scale replacement of the traditional analog technologies in the very near future.

Digital video could be transmitted over satellite links, cable TV systems, terrestrial radio, or networks using various technologies. One thing currently in common is that the packaging and transmission of the video streams are usually achieved using MPEG-2 transport streams. Even though, in the future, the trend of video digitization is shifting toward newer standards such as H.264 (MPEG-4 part 10), the packaging and transmission of the video streams are still very likely to use MPEG-2 transport streams.

The timing model of the MPEG-2 transport stream is based on the assumption that the time delay between the encoder at the sending end and the decoder at the receiving end is constant, which, in reality, is not always the case. The transmission jitter is especially significant when the transport stream is transmitted over a network such as a public Internet. FIG. 1 is a schematic diagram showing a conventional MPEG-2 transport stream transmitted over a network. As illustrated, video, audio, and data signals from multiple program sources are encoded and multiplexed by a MPEG encoder 10 driven by a clock generator 12 into a transport stream 20, which is a series of packets having a constant bit rate A. The MPEG encoder 10 would periodically insert so-called program reference clock (PCR) packets into the transport stream 20, whose main purpose is for the receiving end to generate a clock synchronized to that of the clock generator 12.

The packets of the transport steam 20 are then encapsulated by a network converter 14 according to the network transmission protocol (such as TCP, UDP, and IP) in appropriate network packets 30 as payloads. These network packets 30 then go through a network 40 and reach a transport stream converter 54 at the receiving end. The transport stream converter 54 performs an exact opposite task to that of the network converter 14. The transport stream converter 54 takes out the payloads of the network packets 30 and restores them back to a series of packets 60 conforming to the transport stream format. Please note that, due to the various delays introduced by the network transmission, these packets 60 no longer possess the same constant bit rate A as the transport steam 20 at the sending end.

Conventionally, the packets 60 are placed in a first-in-first-out (FIFO) buffer 56 to reduce the impact of the network jitter resulted from the variance of network transmission delay. Subsequently, an audio-video (AV) stream shaper 58 retrieves packets 60 from the buffer 56, generates a transport stream 70 having a constant bit rate B utilizing a local voltage-controlled clock generator 52, and feeds the transport stream 70 to a MPEG decoder 50. Please note that, as the transport stream 70 is reconstructed by the AV stream shaper 58, the packet length and the gap time between consecutive packets are not necessarily identical to those of the transport stream 20 at the sending end. However, the MPEG decoder 50 would utilize the PCR packets in the transport stream 70 to speed up or slow down the local clock generator 52 so that the constant bit rate B would be identical to the constant bit rate A.

In reality, the local clock generator 52 at the receiving end and the clock generator 12 at the sending end are difficult to maintain synchronized. The conventional method of utilizing the PCR packets to adjust the local clock generator 52 would lead to overflow or underflow of the buffer 56 when the network jitter is serious, which in turn would cause the audio and video signals reproduced by the MPEG decoder 50 to suffer discontinuous frames and intermittent voices. On the other hand, another drawback of using PCR packets for adjusting local clock to approach the sending end clock is the instable recovering clock unable to maintain a steady constant bit rate B for transport stream 70 and the MPEG decoder 50 unable to reproduce high-quality audio and video signals. For example, the receiving end with such an instable recovering clock would cause the instable chroma sub-carrier and therefore result the color phase shifting in the reproduced video frames.

### SUMMARY OF THE INVENTION

Accordingly, to obviate the foregoing drawbacks in using PCR packets to synchronize clock at the transport stream's receiving end, the present invention provides a device and method to replace the conventional PCR packet-based synchronization. The present invention, besides capable of avoiding buffer overflow and underflow, could make the receiving end's clock re-approach the sending end's clock much more quickly and more stably.

The device and method disclosed by the present invention could be applied to transport streams transmitted over satellite links, cable TV systems, terrestrial radio, and networks. The present invention is not limited to MPEG-2 transport stream only, but also any packet transmission systems having similar buffering mechanism and requiring the sending and receiving ends to get synchronization. FIG. 2 is a schematic diagram showing a MPEG-2 transport stream system according to the present invention. As shown in FIG. 2, the clocking synchronizing device 80 of the present invention is located between a transport stream converter 54 and a MPEG decoder 50 at the receiving end. With the clock synchronizing device 80 of the present invention, the MPEG decoder 50 would receive a transport stream having a constant bit rate identical to that of the sending end. The clock synchronizing device 80 of the present invention also supplies a clock to the MPEG decoder 50.

The clock synchronizing device 80 of the present invention contains a buffer 86, an AV stream shaper 88, a controllable clock generator 82, and, most importantly, a clock adjustment module 84. The method provided by the present invention is about how to achieve a synchronized clock at the receiving end. According to the method provided by the present invention, three thresholds, which are named the low threshold, medium threshold, and high threshold, are configured for the buffer 86. If the sending end's clock is faster than the receiving end and the number of packets 60 starts to increase in the buffer 86 up to the high threshold, the present method accelerates the clock generator 82 so that the AV stream shaper 88 and the subsequent MPEG decoder 50 consumes the packets 60 in the buffer 86 faster. When the number of the packets 60 in the buffer 86 drops back to the medium threshold, the present method restores the clock generator 82 to its default frequency. Similarly, if the sending end's clock is slower than the receiving end and the number of packets 60 starts to decrease in the buffer 86 down to the low threshold, the present method decelerates the clock generator 82 so that the AV stream shaper 88 and the subsequent MPEG decoder 50 consumes the packets 60 in the buffer 86 slower. When the number of the packets 60 in the buffer 86 rises back to the medium threshold, the present method restores the clock generator 82 to its default frequency. The number of packets 60 in the buffer 86 is referred to the packet volume of the buffer 86 hereinafter. The most significant feature of the present invention is that the adjustment quantity for accelerating or decelerating the clock generator 82, as well as its default frequency, is determined based on the speed of accumulation or depletion of the packet volume of the buffer 86. By exploiting such a technique, the frequency of the clock generator 82 is prevented from significant fluctuations, and therefore approaches the clock frequency of the sending end more quickly and stably.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a conventional MPEG-2 transport stream transmitted over a network.

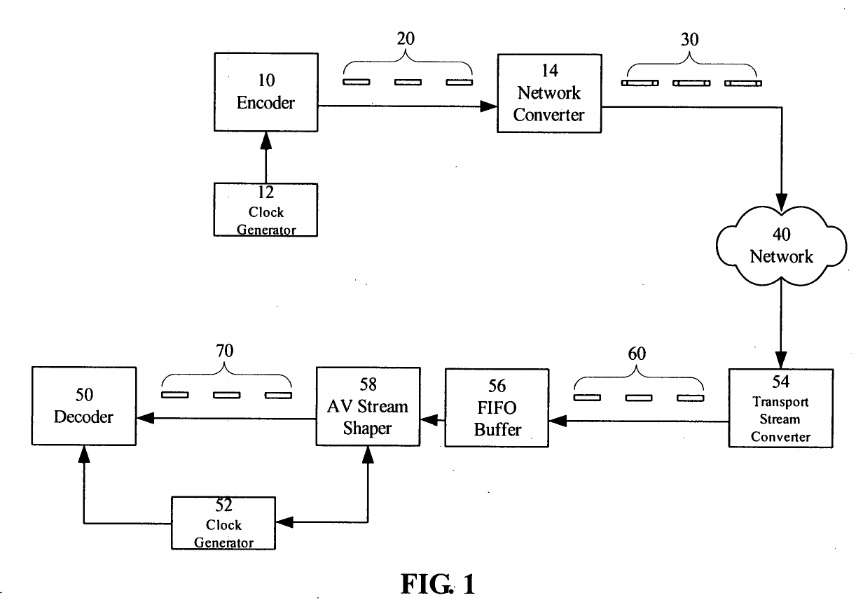

FIG. 2 is a schematic diagram showing a MPEG-2 transport stream system according to the present invention.

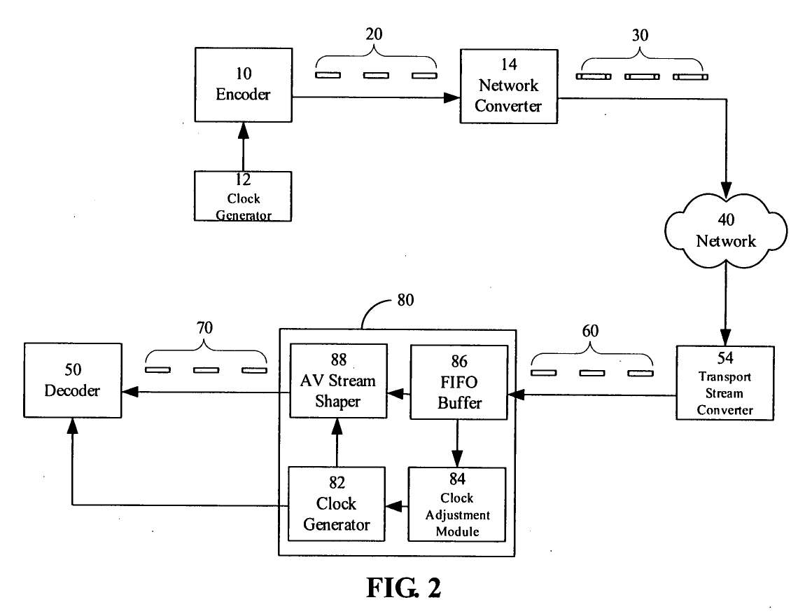

FIG. 3 is a schematic diagram showing a clock synchronizing device according to an embodiment of the present invention.

FIG. 4 shows the waveforms of the relationship among the pulse width modulator, the low pass filter, and the clock generator according an embodiment of the present invention.

FIG. 5 is a schematic diagram showing the buffer's packet volume accumulation and depletion according to an embodiment of the present invention.

### DETAILED DESCRIPTION OF THE PREFERRED EMBODIMENTS

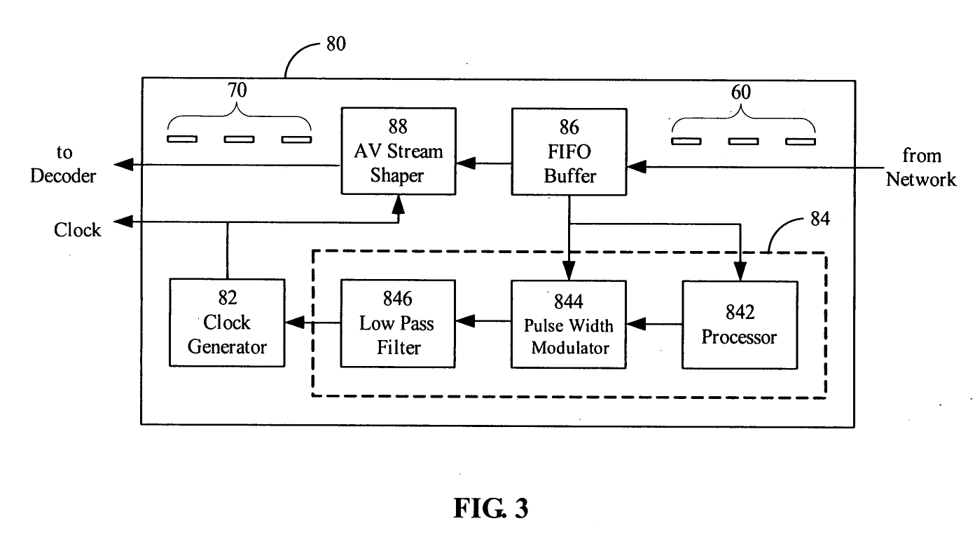

FIG. 3 is a schematic diagram showing a clock synchronizing device according to an embodiment of the present invention. As illustrated, the clock synchronizing device 80 includes a buffer 86, an AV stream shaper 88, a controllable clock generator 82, and a clock adjustment module 84. The clock adjustment module 84, in turn, contains a processor 842, a pulse width modulator (PWM) 844, and a low pass filter 846. Please note that only those most important components of the clock synchronizing device 80 are specified here. For simplification reason, the auxiliary components, such as the power supply, the storage of firmware for the processor 842, etc, are neglected hereinafter.

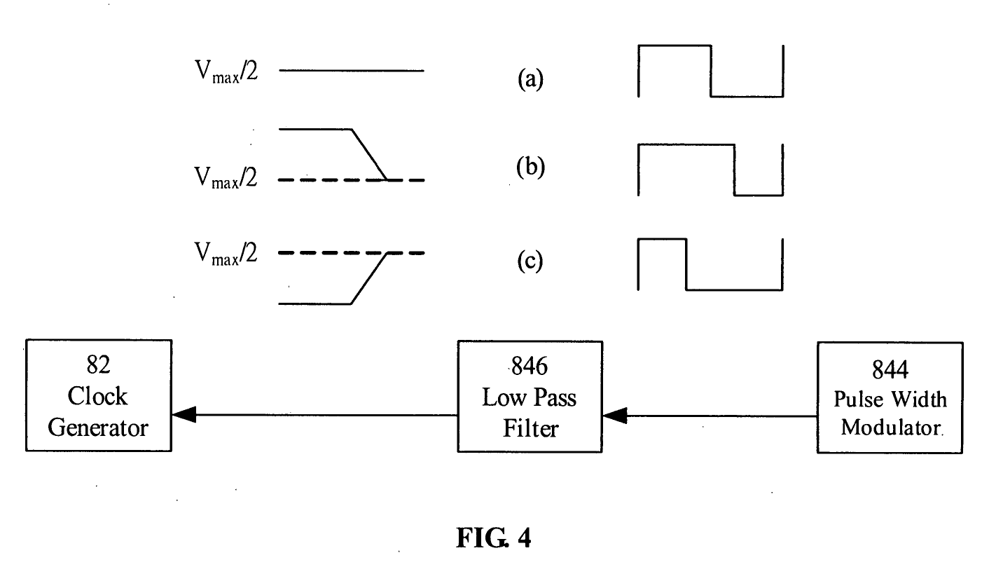

In the present embodiment, the clock generator 82 is a voltage-controlled clock generator which accepts a control voltage no greater than Vₘₐₓ and supplies a corresponding clock whose frequency is no greater than fₘₐₓ. In other words, by adjusting the control voltage, the clock generator 82 is able to supply a clock with a desired frequency. In alternative embodiments, the clock generator 82 could also be controlled by means other than voltage. The control voltage to the clock generator 82 is supplied by the low pass filter 846, which in turn is controlled by the PWM 844. The relationship among the three components is depicted in FIG. 4.

FIG. 4 shows the waveforms of the signals issued between the components of a clock adjustment module according an embodiment of the present invention. Among them, the PWM 844 provides a square wave whose duty cycle is adjustable. Based on the duty cycle of the square wave, the low pass filter 846 produces an output voltage with a corresponding level. In the present embodiment, as shown in the example (a) of FIG. 4, the default duty cycle of the square wave provided by the PWM 844 is 50%. Correspondingly, the low pass filter 846 produces an output voltage Vₘₐₓ/2, and the clock generator 82 delivers a clock whose frequency is fₘₐₓ/2. If the PWM 844 increases the duty cycle of its square wave from 50% to 60% (the adjustment quantity is +10%), as in the example (b) of FIG. 4, the low pass filter 846 would therefore produce an output voltage 10% higher than Vₘₐₓ/2, and the clock generator 82 would deliver a clock whose frequency is 10% faster than fₘₐₓ/2. Similarly, in the present embodiment, if the PWM 844 decreases the duty cycle of its square wave from 50% to 40% (the adjustment quantity is −10%), as in the example (c) of FIG. 4, the low pass filter 846 would therefore produce an output voltage 10% lower than Vₘₐₓ/2, and the clock generator 82 would deliver a clock whose frequency is 10% slower than fₘₐₓ/2.

In summary, the clock synchronizing device 80 could precisely control the clock frequency of the clock generator 82 by adjusting the duty cycle of the PWM 844's square wave. Please note that the present invention focuses on the control of two aspects of the PWM 844. One aspect is the default duty cycle of the square wave, and the other one is the default adjustment quantity. In the present embodiment, the default duty cycle is originally 50%. Then, if required, the present embodiment would adjust the default duty cycle based on how fast the packet volume of the buffer 86 rises or drops. More specifically, if the present embodiment discovers that the clock of the sending end is inherently faster or slower than the local clock, the present embodiment could increase or decrease the default duty cycle to, for example 60% or 40%, to avoid the frequent acceleration or deceleration of the clock generator 82. Once the default duty cycle is changed, the PWM 844 would continue to provide a square wave based on the new default duty cycle. If further adjustment is required, the default adjustment quantity is applied on the new default duty cycle. In the present embodiment, the default duty cycle is initially 50%. In other embodiments, this may not always be the case.

Besides the default duty cycle, the default adjustment quantity for the PWM 844 is also increased or decreased, based on the status of the buffer 86. The buffer 86 has a pre-determined capacity for accommodating packets and, based on the capacity, three thresholds are configured by the present embodiment in terms of the packet volume of the buffer 86. In the present embodiment, the medium threshold is at exactly half of the buffer 86's capacity while the low threshold is lower than the medium threshold, and the high threshold is higher than the medium threshold. Other embodiments may be designed to use different positions for the thresholds. In general, the larger the differences between the low and medium thresholds, and between the medium and high thresholds, the better the clock synchronizing device 80 absorbs the jitter effect resulted from the network transmission delay.

The clock synchronizing device 80 starts to work and the AV stream shaper 88 begins to retrieve packets from the buffer 86 when the packets in the buffer 86 accumulates to the medium threshold. From this point on, the PWM 844 of the present embodiment provides a square wave having a 50% duty cycle, and the clock generator 82 delivers a clock whose frequency is fₘₐₓ/2. Please note that fₘₐₓ/2 is designed to be identical or very close to the clock frequency of the sending end.

In the following, the clock at the sending end is assumed to be slightly faster than the local clock. Due to this lack of synchronization, the packets 60 enter into the buffer 86 faster than they are retrieved by the AV stream shaper 88. The packets 60 in the buffer 86 thereby start to accumulate. When the packet volume of the buffer 86 reaches the high threshold, the PWM 844 is triggered, or the PWM 844 detects such a situation by constantly monitoring the buffer 86. The PWM 844 then immediately increases the duty cycle of its square wave by a default quantity of adjustment. The low pass filter 846 thereby produces an output voltage higher than Vₘₐₓ/2, the clock generator 82 delivers a clock whose frequency is faster than fₘₐₓ/2, and the AV stream shaper 88 retrieves the packets 60 faster. By such an adjustment, the accumulation of the packets 60 is resolved and, when the packet volume of the buffer 86 drops back to the medium threshold, the PWM 844 restores its square wave to the default duty cycle (50%), the low pass filter 846 again produces an output voltage Vₘₐₓ/2, and the clock generator delivers a clock whose frequency is fₘₐₓ/2.

On the other hand, if the clock at the sending end is slightly slower than the local clock. The packets 60 enter into the buffer 86 slower than they are retrieved by the AV stream shaper 88. The packets 60 in the buffer 86 thereby start to deplete. When the packet volume of the buffer 86 drops to the low threshold, the PWM 844 is triggered, or the PWM 844 detects such a situation by constantly monitoring the buffer 86. The PWM 844 then immediately decreases the duty cycle of its square wave by a default adjustment quantity. The low pass filter 846 thereby produces an output voltage lower than Vₘₐₓ/2, the clock generator 82 delivers a clock whose frequency is slower than fₘₐₓ/2, and the AV stream shaper 88 retrieves the packets 60 slower. By such an adjustment, the depletion of the packets 60 is resolved and, when the packet volume of the buffer 86 rises back to the medium threshold, the PWM 844 restores its square wave to the default duty cycle (50%), the low pass filter 846 again produces an output voltage Vₘₐₓ/2, and the clock generator delivers a clock whose frequency is fₘₐₓ/2. With the foregoing method, the buffer 86 is prevented from packet overflow or underflow, the local clock approaches the clock at the sending end, and on the average the constant bit rate B is the same as the constant bit rate A.

However, if the clock at the sending end is inherently faster (or slower) than the local clock, based on the foregoing method, the clock generator 82 would be in continuous cycles of acceleration (or deceleration) and restoration from the default frequency. To achieve a better local clock quality, the present invention utilizes the processor 842 to change the default duty cycle as well as the default adjustment quantity of the PWM 844.

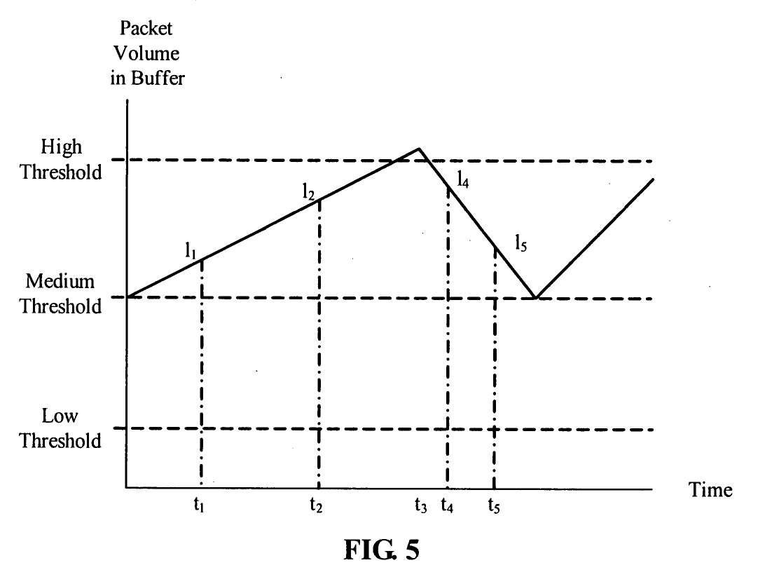

In the following, the clock at the sending end is assumed to be faster than the local clock. When the processor 842 discovers that the packet volume of the buffer 86 varies back and forth between the medium and high thresholds, as illustrated in FIG. 5, the processor 842 would record the levels 1 and 12 of the packet volume of the buffer 86 during its accumulation stage at appropriate times t₁ and t₂. The processor 842 then calculates the speed of packet accumulation as (l₂−l₁)/(t₂−t₁), which is directly related to the difference between the sending clock frequency and the local clock frequency. The processor 842 therefore changes the default duty cycle currently in use as follows:
New Default Duty Cycle=Original Default Duty Cycle+(l₂−l₁)/(t₂−t₁)×k₁
where k₁ is a pre-determined constant to map the buffer 86's packet volume accumulation speed into an adjustment amount for the default duty cycle.

The new default duty cycle takes effect immediately. However, as there are already accumulated quite a few packets 60, the packet volume of the buffer 86 would still reaches the high threshold after a while. When that happens, the duty cycle of the PWM 844's square wave is again adjusted by adding the default adjustment quantity to the newly adopted default duty cycle. Since the new default duty cycle is already faster, the packets 60 would drop back to the medium threshold much faster. Similarly, during the depletion stage of the buffer 86, the processor 842 would record the levels l₄ and l₅ of the packet volume of the buffer 86 at appropriate times t₄ and t₅. The processor 842 then calculates the speed of packet depletion as (l₄−l₅)/(t₅−t₄), which is directly related to the difference between the sending end clock and the local clock (the result of the new default duty cycle plus the original adjustment quantity). As the original default adjustment quantity would be too large after the default duty cycle is increased, the processor 842 therefore changes the default adjustment quantity currently in use as follows:
New Default Adjustment Quantity=Original Default Adjustment Quantity−(l₄−l₅)/(t₅−t₄)×k₂
where k₂ is a pre-determined constant to map the buffer 86's packet volume depletion speed into an adjustment amount for the adjustment quantity.

If the clock at the sending end is slightly slower than the local clock, the present invention utilizes the same method to decrease the default duty cycle and the default adjustment quantity. The scenario could be easily inferred by the foregoing description and, therefore, for the sake of simplicity, the details are omitted here. Please note that the changes to the default duty cycle and the default adjustment quantity take effect immediately. In addition, in the present embodiment, the processor 842 not only calculates the new default adjustment quantity and the new default duty cycle, but also configures these new settings and the three thresholds into the PWM 844. Subsequently, the PWM 844 automatically follows the configured threshold levels, default duty cycle, and default adjustment quantity to work. However, in other embodiments, other types of implementation are also possible.

In summary, the method provided by the present invention mainly contains two functions. One is to prevent the buffer 86's overflow or underflow, to approach the local clock frequency to the clock frequency of the sending end, and to achieve averagely the constant bit rate B is the same as the constant bit rate A. The other one is to calibrate the default duty cycle and the default adjustment quantity of the PWM 844 based on the speeds of the buffer 86's packet volume accumulation and depletion, so that the local clock frequency could approach the clock frequency at the sending end much faster and stably.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A clock synchronizing device at a receiving end of a transport stream system, an encoder located at a sending end of said transport stream system to encode audio/video data into a plurality of packets according to a first clock, said packets transmitted via a communications mechanism to said clock synchronizing device, said clock synchronizing device adjusting a second clock to approach said first clock and sending said packets according to said second clock to a decoder for reproducing said audio/video data, said clock synchronizing device comprising:
a buffer which receives said packets, said buffer having a packet volume representing a current amount of said packets in said buffer;
a stream shaper which retrieves said packets from said buffer and sends said packets to said decoder according to said second clock;
a clock generator which provides said second clock to said stream shaper under the control of a clock adjustment module; and
a clock adjustment module,
which makes said clock generator to produce said second clock having a default frequency when said packet volume of said buffer remains below a high threshold and above a low threshold;
which accelerates said clock generator to increase said second clock's frequency by a default frequency adjustment quantity when said packet volume of said buffer rises to said high threshold and then restores said second clock back to said default frequency when said packet volume of said buffer drops back to a medium threshold;
which decelerates said clock generator to decrease said second clock's frequency by said default frequency adjustment quantity when said packet volume of said buffer drops to said low threshold and then restores said second clock back to said default frequency when said packet volume of said buffer rises back to said medium threshold;
which, when discovering said first clock is faster than said second clock, increases said default frequency of said second clock based on an accumulation speed of said packet volume of said buffer and decreases said default frequency adjustment quantity of said second clock based on an depletion speed of said packet volume of said buffer; and
which, when discovering said first clock is slower than said second clock, decreases said default frequency of said second clock based on an depletion speed of said packet volume of said buffer and decreases said default frequency adjustment quantity of said second clock based on an accumulation speed of said packet volume of said buffer.

2. The clock synchronizing device as claimed in claim 1, wherein said communications mechanism is selected from a group consisting of satellite link, cable TV system, terrestrial radio, and network.

3. The clock synchronizing device as claimed in claim 1, wherein said encoder and said decoder perform MPEG standard-compliant encoding and decoding.

4. The clock synchronizing device as claimed in claim 1, wherein said second clock's frequency is controlled by a control voltage applied to said clock generator, and wherein said clock adjustment module comprises:
a pulse width modulator,
which produces a square wave having a default duty cycle when said packet volume of said buffer remains below said high threshold and above said low threshold;
which increases said square wave's duty cycle by said default cycle adjustment quantity when said packet volume of said buffer rises to said high threshold and then restores said square wave to said default duty cycle when said packet volume of said buffer drops back to said medium threshold; and
which decreases said square wave's duty cycle by said default cycle adjustment quantity when said packet volume of said buffer drops to said low threshold and then restores said square wave to said default duty cycle when said packet volume of said buffer rises back to said medium threshold;
a low pass filter,
which takes said square wave of said pulse width modulator as input and generates said control voltage whose level is determined by said square wave's duty cycle to said clock generator;
which generates said control voltage to have a level such that said second clock is of said default frequency when said square wave has said default duty cycle; and
which adjusts said control voltage by an amount such that said second clock undergoes a frequency change equal to said default frequency adjustment quantity when said square wave's duty cycle undergoes a change equal to said default cycle adjustment quantity; and
a processor,
which, when said processor discovers said first clock is faster than said second clock, configures said pulse width modulator to have a new default duty cycle by increasing said default duty cycle with an amount proportional to an accumulation speed of said packet volume of said buffer measured when said packet volume rises towards said high threshold, and configures said pulse width modulator to have a new default cycle adjustment quantity by decreasing said default cycle adjustment quantity with an amount proportional to a depletion speed of said packet volume of said buffer measured when said packet volume reaches said high threshold and then drops toward said medium threshold; and
which, when said processor discovers said first clock is slower than said second clock, configures said pulse width modulator to have a new default duty cycle by decreasing said default duty cycle with an amount proportional to an depletion speed of said packet volume of said buffer measured when said packet volume drops towards said low threshold, and configures said pulse width modulator to have a new default cycle adjustment quantity by decreasing said default cycle adjustment quantity with an amount proportional to an accumulation speed of said packet volume of said buffer measured when said packet volume reaches said low threshold and then rises toward said medium threshold.

5. The clock synchronizing device as claimed in claim 4, wherein said new default duty cycle and said new default cycle adjustment quantity take effect immediately once they are configured by said processor into said pulse width modulator.

6. The clock synchronizing device as claimed in claim 1, wherein said packets are transport stream packets.

7. The clock synchronizing device as claimed in claim 1, wherein said packets have a MPEG compliant format.

8. A clock synchronizing method applied at a receiving end of a transport stream system, an encoder located at a sending end of said transport stream system to encode audio/video data into a plurality of packets according to a first clock, said packets transmitted via a communications mechanism to said receiving end and stored in a buffer, said buffer having a packet volume representing a current amount of said packets in said buffer, an stream shaper retrieving said packets from said buffer and sending said packets according to a second clock to a decoder for reproducing said audio/video data, said clock synchronizing method producing and adjusting said second clock to approach said first clock, said clock synchronizing method comprising the following steps in parallel:
producing said second clock to have a default frequency when said packet volume of said buffer remains below a high threshold and above a low threshold;
increasing said second clock's frequency from said default frequency by a default frequency adjustment quantity when said packet volume of said buffer rises to said high threshold and then restoring said second clock back to said default frequency when said packet volume of said buffer drops back to a medium threshold;
decreasing said second clock's frequency from said default frequency by said default frequency adjustment quantity when said packet volume of said buffer drops to said low threshold and then restoring said second clock back to said default frequency when said packet volume of said buffer rises back to said medium threshold;
increasing said default frequency and decreasing said default frequency adjustment quantity of said second clock when discovering said first clock is faster than said second clock; and
decreasing said default frequency and decreasing said default frequency adjustment quantity of said second clock when discovering said first clock is slower than said second clock.

9. The clock synchronizing method as claimed in claim 8, wherein said communications mechanism is selected from a group consisting of satellite link, cable TV system, terrestrial radio, and network.

10. The clock synchronizing method as claimed in claim 8, wherein said encoder and said decoder perform MPEG standard-compliant encoding and decoding.

11. The clock synchronizing method as claimed in claim 8, wherein the step of increasing said default frequency and decreasing said default frequency adjustment quantity further comprises:
calculating an accumulation speed of said packet volume of said buffer when said packet volume rises towards said high threshold;
obtaining a new default frequency by increasing said default frequency with an amount proportional to said accumulation speed and configuring said new default frequency as said default frequency;
calculating an depletion speed of said packet volume of said buffer when said packet volume reaches said high threshold and then drops toward said medium threshold; and
obtaining a new default frequency adjustment quantity by decreasing said default frequency adjustment quantity with an amount proportional to said depletion speed and configuring said new default frequency adjustment quantity as said default frequency adjustment quantity.

12. The clock synchronizing method as claimed in claim 8, wherein the step of decreasing said default frequency and decreasing said default frequency adjustment quantity further comprises:
calculating a depletion speed of said packet volume of said buffer when said packet volume drops towards said low threshold;
obtaining a new default frequency by decreasing said default frequency with an amount proportional to said depletion speed and configuring said new default frequency as said default frequency;
calculating an accumulation speed of said packet volume of said buffer when said packet volume reaches said low threshold and then rises toward said medium threshold; and
obtaining a new default frequency adjustment quantity by decreasing said default frequency adjustment quantity with an amount proportional to said accumulation speed and configuring said new default frequency adjustment quantity as said default frequency adjustment quantity.

13. The clock synchronizing method as claimed in claim 8, wherein said packets are transport stream packets.

14. The clock synchronizing method as claimed in claim 8, wherein said packets have a MPEG compliant format.
